(19) United States
(12) Patent Application Publication
(10) Pub. No.: US 2006/0250588 A1
(43) Pub. Date: Nov. 9, 2006

(54) Immersion exposure tool cleaning system and method

(76) Inventor: Stefan Brandl, Albany, NY (US)

Correspondence Address: SLATER & MATSIL LLP, 17950 PRESTON ROAD, SUITE 1000, DALLAS, TX, 75252, US

(21) Appl. No.: 11/120,929

(22) Filed: May 3, 2005

(51) Int. Cl. G03B 27/52

(52) U.S. Cl. 355/30; 355/53

(57) ABSTRACT

Methods of cleaning immersion exposure tools using ultrasonic waves and systems thereof are disclosed. An ultrasonic wave generator is coupled to the fluid of an immersion exposure tool, or to a component that makes contact with the fluid. The ultrasonic wave generator is activated, generating ultrasonic waves in the fluid that dislodge debris and particulates, cleaning the immersion exposure tool. The ultrasonic wave generator may be activated during an exposure process to vary the distance between the lens system and the wafer, increasing the process window.

### TECHNICAL FIELD

The present invention relates generally to lithography systems used to manufacture semiconductor devices, and more particularly to immersion lithography systems and immersion exposure tools.

### BACKGROUND

Semiconductor devices are manufactured by depositing many different types of material layers over a semiconductor workpiece or wafer, and patterning the various material layers using lithography. The material layers typically comprise thin films of conductive, semiconductive, and insulating materials that are patterned and etched to form integrated circuits (IC's).

For many years in the semiconductor industry, optical lithography techniques such as contact printing, proximity printing, and projection printing have been used to pattern material layers of integrated circuits. Projection printing is commonly used in the semiconductor industry using wavelengths of 248 nm or 193 nm, as examples. At such wavelengths, lens projection systems and transmission lithography masks are used for patterning, wherein light is passed through the lithography mask to impinge upon a wafer.

However, as the minimum feature sizes of IC's are decreased, the semiconductor industry is exploring the use of alternatives to traditional optical lithography techniques, in order to meet the demand for decreased feature sizes in the industry. For example, short wavelength lithography techniques, Scalpel, other non-optical lithographic techniques, and immersion lithography are under development as replacements for traditional optical lithography techniques.

One lithography technique under development is immersion lithography, in which the gap between the last lens element in the optics system and a semiconductor wafer is filled with a liquid, such as water, to enhance system performance. The presence of the liquid enables the index of refraction in the image space, and therefore the numerical aperture of the projection system, to be greater than unity. Thus, immersion lithography has the potential to extend 193 nm tools used in lithography down to about 45 nm or below, for example.

FIG. 1 shows a perspective view of portion of a prior art immersion lithography system or immersion exposure tool 100. Such an immersion exposure tool 100 is described in “Technology Backgrounder: Immersion Lithography,” from the website: http://www.icknowledge.com/misc_technology/Immersion %20Lithography.pdf, which is incorporated herein by reference. Immersion exposure tools are described in further detail in U.S. Patent Application No. 2005/0046813 A1, published on Mar. 3, 2005, for example, which is also incorporated herein by reference.

The portion of the immersion exposure tool 100 shown in FIG. 1 includes a wafer 102 mounted on a wafer support 104. The wafer support 104 is also referred to as a wafer stage or exposure chuck, for example.

A projection lens system 108 is disposed proximate the wafer 102. A fluid 106 such as water or other type of liquid is introduced between the last element 110 of the lens system 108 and the wafer 102 during the exposure process, e.g., by an immersion head or shower head 120 clamped to the end of the lens system 108 or to another part of the exposure tool 100. The wafer support 104 and wafer 102 are moved during the patterning of the individual die or regions of die 112 on the wafer 102. The fluid 106 is typically provided by a nozzle or by input and output ports within the immersion head 120, for example.

The fluid 106 generally continuously flows, to provide temperature stability for the immersion head and other components of the immersion exposure tool 100. In some immersion exposure tools 100, when the lens system 108 is not being used to expose the wafer 102, a closing disk 130 is used to close the end of the immersion head 120. The closing disk 130 may be disposed on the same wafer support 104 that supports the wafer 102, for example. The closing disk 130 typically comprises quartz, calcium fluoride, a glass or ceramic material such as Zerodur® (a registered trademark by Schott AG), or other materials, as examples. The closing disk 130 provides a fluid 106 seal and prevents the fluid 106 from leaking onto undesired portions of the immersion exposure tool 100, for example. The immersion head 120 may be adapted to lift the closing disk 130 using vacuum ports 126 or air ports 132 (see FIG. 2), for example. The closing disk 130 may be positioned on the immersion head 120 while a wafer 102 is moved from the support 104 and another wafer 102 to be exposed is moved to the support 104, for example. The wafer support 104 has recessed areas formed therein so that the wafer 102 and a closing disk 130 are recessed when placed on the wafer support 104, as shown.

Alternatively, in some immersion exposure tools 100, a separate secondary support 113 located proximate the lens system 108, shown in phantom, may be used to close the immersion head 120 and seal the fluid 106, for example. The secondary support 113 may be moved under the immersion head 120 to prevent the fluid 106 from leaking while the fluid 106 is flowing.

FIG. 2 shows a more detailed cross-sectional view of the portion of the prior art immersion exposure tool 100 shown in FIG. 1. The immersion exposure tool 100 includes an immersion head 120 disposed proximate the last element 110 of the lens system 108, e.g., clamped or attached to the lens system 108 or to another part of the exposure tool 100. An immersion head 120 such as the one shown in FIG. 2 is also referred to in the art as a shower head, for example. The immersion head 120 includes ports 122 and 124 for supplying the fluid 106 between the wafer 102 and the immersion head 120. The ports 122 and 124 may comprise input and output ports for the fluid 106, respectively, for example. Hoses (not shown) may be coupled to the ports 122 and 124 for injecting and removing H₂O and/or other fluids or solvents, for example.

The immersion head 120 may also include vacuum ports 126 disposed proximate the fluid ports 122 and 124. The vacuum ports 126 may be used to ensure that the fluid 106 stays only immediately beneath the immersion head 120 central region, for example. The immersion head 120 may optionally also include air ports 132 disposed proximate the vacuum ports 126, as shown. The fluid ports 122 and 124 may comprise a plurality of ports 122/124 arranged in a ring having a first diameter, and the vacuum ports 126 may comprise a plurality of ports 126 arranged in a ring having a second diameter and being concentric with the fluid ports 122/124, wherein the second diameter is larger than the first diameter, for example. The optional air ports 132 may comprise a plurality of ports 132 arranged in a ring having a third diameter and being concentric with the fluid ports 122/124 and vacuum ports 126, wherein the third diameter is larger than the second diameter, for example. The air ports 132 may be used to lift the closing disk 130 using a vacuum, for example.

The wafer 102 typically includes a workpiece 114 with a layer of radiation sensitive material 116 such as photoresist disposed thereon. The pattern from a mask or reticle (not shown) is imaged onto the photoresist 116 using a beam of radiation or light emitted from the lens system 108. The beam is emitted from an energy source, not shown, such as a light source, and the beam is passed through the lens system 108 to the photoresist 116. After exposure of the photoresist 116, the patterned photoresist 116 is later used as a mask while portions of a material layer (not shown) disposed over the workpiece 114 are etched away (also not shown).

FIG. 3 is another prior art drawing that illustrates a closing disk 130 placed in position beneath an immersion head 120. The closing disk 130 keeps the last element 110 of the lens system 108 wet with the fluid 106 to avoid forming drying stains on the element 110, which could interfere with the transfer of the mask pattern to a wafer 102, for example. The immersion head 120 may lift the closing disk 130 using the vacuum ports 126 or the optional air ports 132, for example, or alternatively, the immersion head 120 may be placed in contact with the closing disk 130 while it remains positioned on a wafer support 104 (as shown in FIG. 1), for example.

A problem with the prior art immersion exposure tool 100 shown is that particulates 136 may form and be suspended in the fluid 106 and may lodge on various surfaces, as shown in a cross-sectional view in FIG. 4. Particulates 136a, 136b, 136c, and 136d are referred to herein collectively as particulates 136.

The particulates 136 may comprise debris from the photoresist 116, or debris from the material of the immersion head 120 or closing disk 130, as examples. The particulates 136 may comprise debris from the material of the wafer support 104, for example. The particulates 136 may alternatively also comprise other materials or combinations of materials that may be present or that may be introduced into the immersion exposure tool 100, for example.

As an example of particulate 136 formation, when the closing disk 130 is used to fluidly seal the immersion head 120 during wafer 102 changes, direct contact is made to the bottom surface of the immersion head 120. The closing disk 130 can shift and scratch the to the bottom surface of the immersion head 120. The closing disk 130 can shift and scratch the immersion head 120 bottom surface. The immersion head 120 can also scratch the top surface of the closing disk 130. This scratching can create the particulates 136, e.g., which may comprise debris from the scratched immersion head 120 and/or closing disk 130, which can enter the fluid 106 or become adhered to surfaces the fluid 106 comes into contact with. The particulates 136 may also originate by the closing disk 130 making contact with the wafer support 104, for example.

The particulates 136 may be suspended in the fluid 106, as shown at 136a, and may become adhered to the wafer 102, as shown at 136b. The particulates may also become adhered to the last element 110 of the lens system 108, as shown at 136c. The particulates may become adhered to the immersion head 120 bottom surface, as shown at 136d, for example. Furthermore, the particulates may also become lodged on the closing disk 130, not shown.

As the wafer support moves the wafer 102 during the exposure process, particulates 136 that are adhered to surfaces may break loose and move to other surfaces or may remain suspended in the fluid 106. The particulates 136a may comprise a diameter of about 200 to 500 nm, for example, although alternatively, the particulates 136a may comprise other dimensions.

The particulates 136 may be large enough to deleteriously affect the exposure process. For example, if the particulates 136 are present in the fluid 106 in the path of the energy used to irradiate the radiation sensitive material 116 on the wafer 102 in the exposure process, a defect may be formed on the wafer 102, decreasing semiconductor device yields.

Thus, what are needed in the art are methods of cleaning particulates 136 and debris from immersion exposure tools 100.

### SUMMARY OF THE INVENTION

These and other problems are generally solved or circumvented, and technical advantages are generally achieved, by preferred embodiments of the present invention, which provide novel methods of cleaning particulates and debris from immersion exposure tools. An ultrasonic wave generator is coupled to the fluid of the immersion exposure tool or to a component of the immersion exposure tool that makes contact with the fluid. The ultrasonic wave generator is activated to dislodge particulates or debris from surfaces the fluid comes into contact with. The particulates are then expelled from the immersion head using the existing fluid ports of the immersion head.

In accordance with a preferred embodiment of the present invention, a method of cleaning an immersion exposure tool is disclosed. The immersion exposure tool includes a wafer support, a lens system, and an immersion head adapted to dispose fluid between the lens system and the wafer support. The method includes coupling an ultrasonic wave generator to the fluid or to a component of the immersion exposure tool that makes contact with the fluid, and activating the ultrasonic wave generator.

In accordance with another preferred embodiment of the present invention, a method of lithography for semiconductor devices includes providing an immersion exposure tool having a wafer support, a lens system, and an immersion head adapted to dispose a fluid between the lens system and the wafer support, and providing a workpiece having a radiation sensitive material disposed thereon. An ultrasonic wave generator is coupled to the fluid or to a component of the immersion exposure tool that makes contact with the fluid. The workpiece is positioned on the wafer support, the fluid is disposed between the workpiece and the lens system, the ultrasonic wave generator is activated to clean surfaces the fluid makes contact with. The ultrasonic wave generator is deactivated, and the workpiece is exposed to radiation using the immersion exposure tool.

In accordance with yet another preferred embodiment of the present invention, an immersion exposure tool includes a lens system, a wafer support, and an immersion head disposed between the lens system and the wafer support adapted to dispose a fluid between the lens system and the wafer support. An ultrasonic wave generator is coupled to the fluid or to a component of the immersion exposure tool that makes contact with the fluid.

Advantages of preferred embodiments of the present invention include providing novel methods of cleaning immersion exposure tools, and immersion exposure tools adapted to implement the cleaning methods described herein. A decreased amount of debris and particulates in immersion exposure tools and improved semiconductor device yields of devices manufactured using the immersion exposure tools are achieved. The ultrasonic wave generator may be activated before, during, or after an exposure process.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a portion of a prior art immersion exposure tool, wherein a fluid is disposed between a lens system and wafer during the lithography process;

FIG. 2 is a cross-sectional view of the portion of the prior art immersion exposure tool shown in FIG. 1;

FIG. 3 is a prior art drawing illustrating a closing disk that is used to fluidly seal the immersion head during wafer exchanges;

FIG. 4 is a prior art drawing illustrating particulates that may form and lodge on various surfaces that the fluid comes into contact with;

FIG. 5 is a cross-sectional view of an immersion exposure tool in accordance with an embodiment of the present invention having an ultrasonic wave generator coupled to the fluid or to a component of the immersion exposure tool that makes contact with the fluid, wherein the ultrasonic waves generated by the ultrasonic wave generator into the fluid clean the surfaces of the components that make contact with the fluid of particulates and other debris;

FIG. 6 is a cross-sectional view of another immersion exposure tool in accordance with another embodiment of the present invention, wherein the ultrasonic wave generator is coupled to a wafer support; and

FIG. 7 is a flow chart illustrating a method of cleaning an immersion exposure tool in accordance with an embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

In accordance with a preferred embodiment of the present invention, an ultrasonic wave generator is used to clean particulates and other debris from surfaces fluid comes into contact with during the exposure process. Embodiments of the invention also include methods of cleaning immersion exposure tools, and immersion exposure tools including the ultrasonic wave generator adapted to clean the fluid, to be described further herein.

Referring next to FIG. 5, a cross-sectional view of an immersion exposure tool in accordance with an embodiment of the present invention is shown. Like numerals are used to label the elements in FIG. 5 as were used in the previous figures, and to avoid repetition, each element is not described again in detail.

The immersion exposure tool 200 includes a lens system 208 and an immersion head 220 coupled to the lens system 208 proximate the last lens element 210 of the lens system 208. An ultrasonic wave generator 250 is coupled to the fluid 206 that is disposed between the wafer 202 and the immersion head 220, as shown in phantom, or to a component of the immersion exposure tool that make contact with the fluid 206, such as the immersion head 220, as shown. For example, the ultrasonic wave generator 250 may be coupled directly to the fluid 206, as shown in phantom, e.g., by inserting a rod or other object coupled to the ultrasonic wave generator 250 into the fluid 206 or by inserting a portion of the ultrasonic wave generator 250 into the fluid 206. Alternatively, an ultrasonic wave generator 250 may be coupled to other components of the immersion lithography tool 200 that makes contact with the fluid 206, for example. In one embodiment, the ultrasonic wave generator 250 is coupled only to the fluid 206, for example.

If the ultrasonic wave generator 250 is coupled to the immersion head 220, then when the ultrasonic wave generator 250 is activated, the ultrasonic waves generated vibrate the immersion head 220 and form ultrasonic waves in the fluid 206, for example. The ultrasonic wave generator 250 may be clamped to the immersion head 220 or may be fastened to the immersion head 220 using mechanical fasteners such as screws (not shown) or other fastening and/or attachment means, for example.

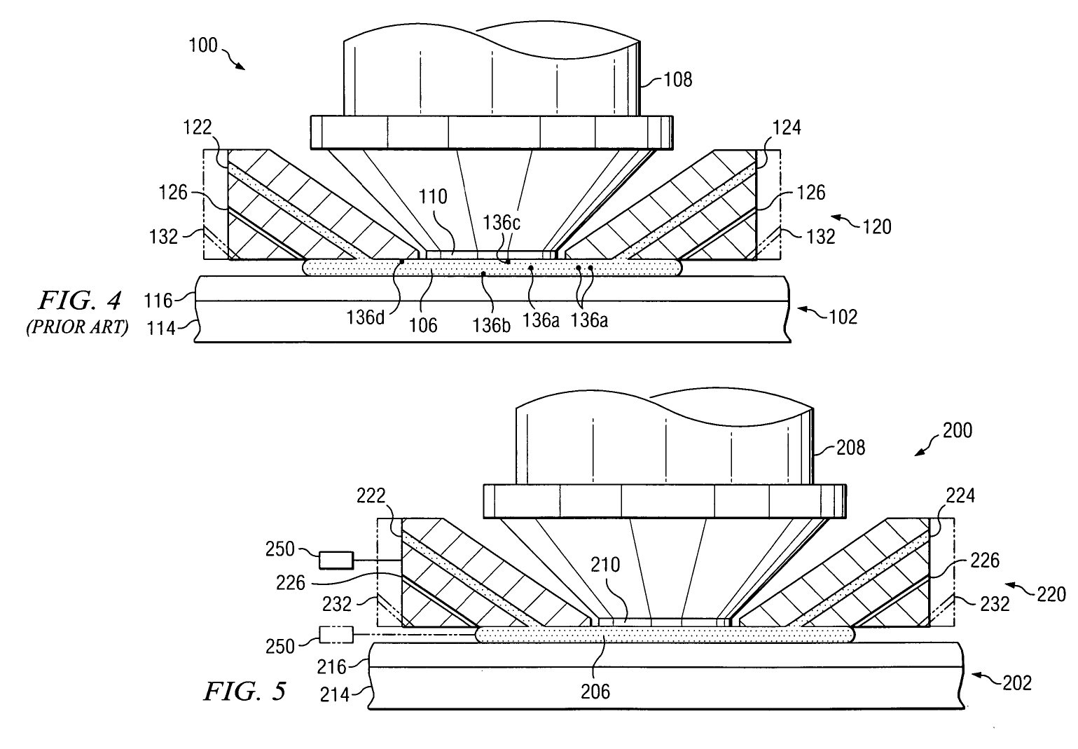

In one embodiment, the ultrasonic wave generator 250 may be activated before or after, or both before and after, the exposure process to introduce ultrasonic waves into the fluid 206. The ultrasonic waves clean the surfaces that the fluid 206 comes into contact with of particulates and other debris, dislodging the particulates (not shown in FIG. 5; see FIG. 4) so that the fluid 206 may carry the particulates away and out of the tool 200 in the fluid 206 flow. The fluid 206 then flows out of the exposure tool 200, removing any particulates that may be present in the fluid 206. In another embodiment, the ultrasonic wave generator 250 may be activated during the exposure process, to be described further herein.

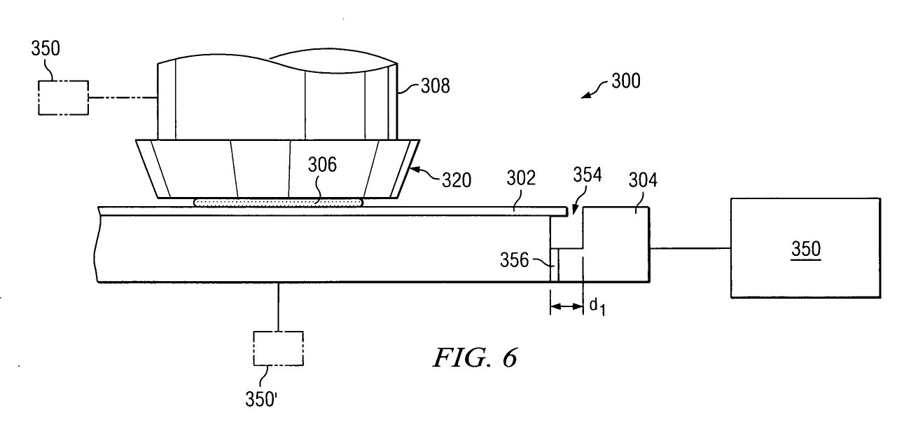

The immersion exposure tool 200 may be cleaned at various stages and in a variety of conditions. The ultrasonic wave generator 250 may be used when a wafer 202 is placed under the immersion head 220 to clean the system 200, for example. The wafer support (not shown in FIG. 5; see FIG. 6 at 304) may be moved under the immersion head 220 to clean a portion of the wafer 202, or to clean the entire wafer 202, for example. The ultrasonic wave generator 250 may be used when a wafer 202 is placed under the immersion head 220 at an edge of the wafer 202, to clean a portion of the wafer 202 at the edge and also to clean a portion of the wafer support proximate the wafer 202, for example.

In another embodiment, the ultrasonic wave generator 250 may be used when a closing disk (such as closing disk 130 shown in FIG. 3) is placed under the immersion head 220 to clean the tool 200, for example.

In yet another embodiment, the ultrasonic wave generator 250 may be used when a wafer is not placed under the immersion head 220 to clean the wafer support, for example. The wafer support may be moved underneath the immersion head 220 to clean a portion of or the entire surface of the wafer support, for example.

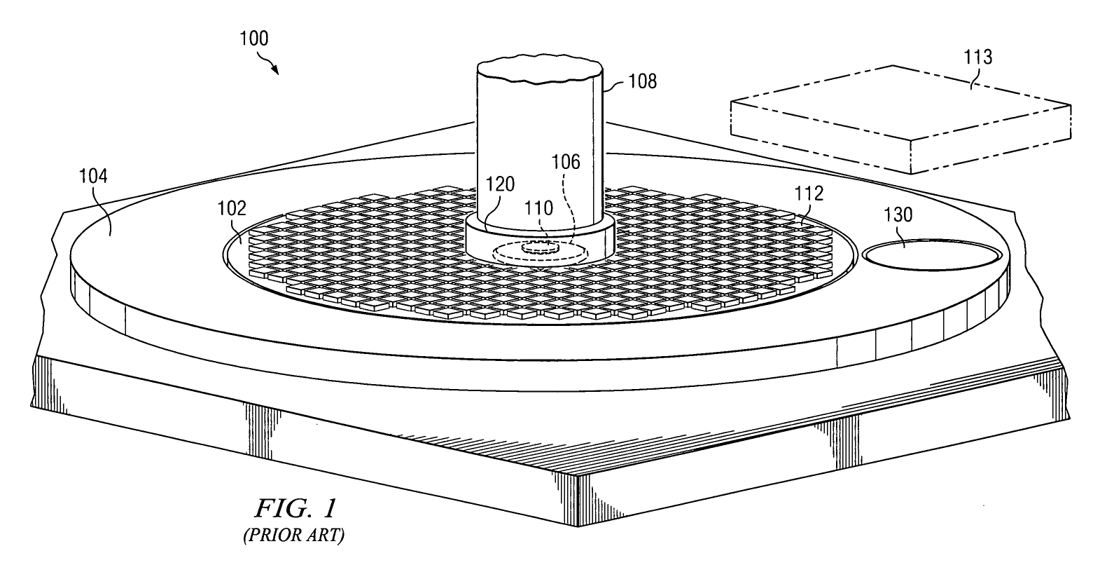

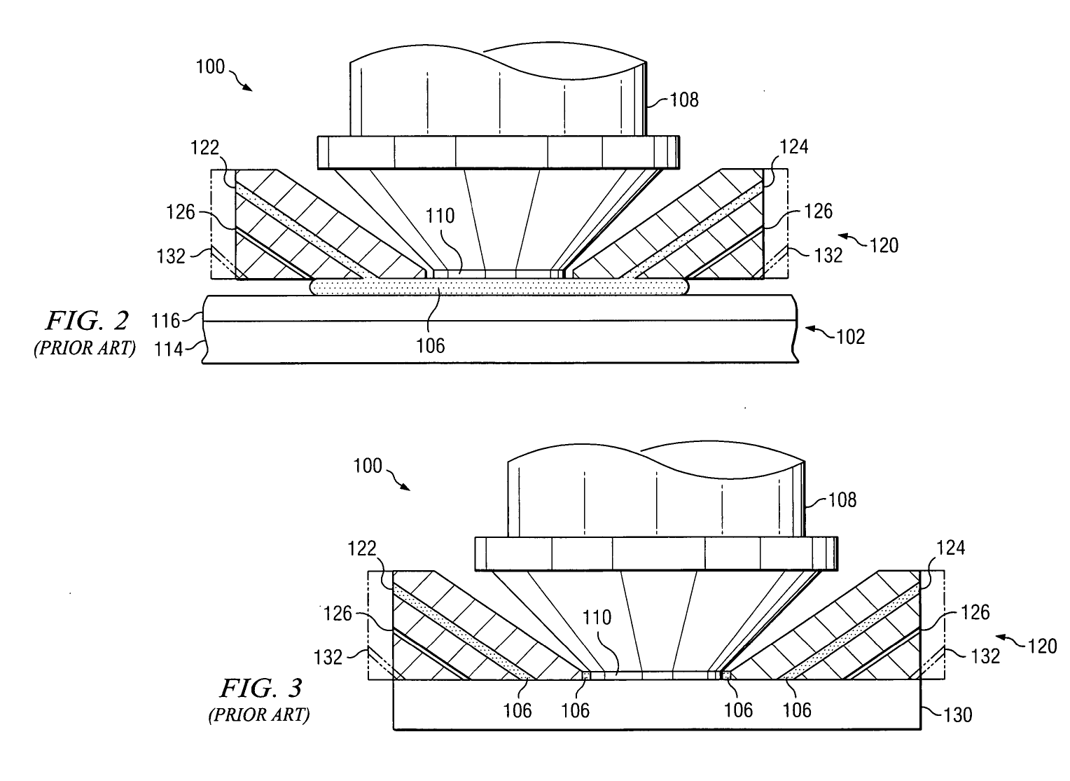

Advantageously, when the ultrasonic wave generator 250 is activated, the surfaces that the fluid 206 makes contact with are cleaned by the ultrasonic waves generated by the ultrasonic wave generator 250. Thus, the bottom surface of the immersion head 220 is cleaned, the last lens element 210 of the immersion head 220 is cleaned, and the ports 222 and 224 are cleaned by the novel ultrasonic cleaning method of embodiments of the present invention, as well as the top surface of the object, e.g., wafer 202, closing disk 130 (shown in FIG. 1), the same wafer support 104 that a wafer 102 is supported by (see FIG. 1), or a separate secondary support 113 (also shown in FIG. 1), placed beneath the immersion head 220.

In one embodiment, the ultrasonic wave generator 350 is preferably coupled to the wafer support 304, as shown in a cross-sectional view in FIG. 6. In another embodiment, the ultrasonic wave generator 350 may be coupled to the lens system 308, as shown in phantom. Again, like numerals are used for the elements in FIG. 6 as were used in the previous figures. The ultrasonic waves generated vibrate the wafer support 304 or the lens system 308 and cause the formation of ultrasonic waves in the fluid 306 in this embodiment, for example. The ultrasonic wave generator 350 may be clamped to the wafer support 304 or lens system 308, or fastened to the wafer support 304 or lens system 308 using mechanical fasteners such as screws (not shown) or other fastening and/or attachment means, for example.

Also shown in FIG. 6 is a wafer support 304 having an optional pocket 354. The pocket 354 may have a width d₁ of about 2 mm, as an example, although alternatively, the pocket 354 may comprise other dimensions. The edge of the wafer 302 may extend over the edge of the pocket 354, as shown. The pocket 354 may include a drain port 356, as shown, for facilitating the draining of a portion of the fluid 306, for example. Alternatively, the pocket 354 may be disposed proximate a drain port elsewhere in the wafer support 304, not shown. In this embodiment, pocket 354 of the wafer support 304 may be moved under the immersion head 320 to clean the pocket 354, for example.

Advantageously, the ultrasonic wave generator 350 may be activated during the exposure process, in one embodiment, achieving further benefits in the lithography process. The ultrasonic wave generator 350′ may be coupled to the bottom of a wafer support 304, as shown in phantom, or to the side of the wafer support 304, as shown at 350. In this embodiment, the ultrasonic wave generator 350 or 350′ is preferably adapted to move the wafer support 304, and thus also move the wafer 302, in a vertical direction, e.g., up and down towards and away from the lens system 308 during the exposure process. This is advantageous in that the distance between the lens system 308 and the wafer 302 is changed during the exposure process by the vibrations created by the ultrasonic wave generator 350 or 350′. The plane of focus is changed and moved through the layer of radiation sensitive material (such as layer 216 of wafer 202 shown in FIG. 5) on the wafer 302 as the wafer 302 is moved by the ultrasonic wave generator 350 or 350′. Advantageously, multiple exposures of a layer of photoresist (such as 216 shown in FIG. 5) disposed on a wafer 302 may be avoided by the use of the novel methods and system described herein.

For example, in some lithography processes, such as those used to pattern contact holes, a relatively thick photoresist is used, and two or more exposures at varying heights within the photoresist are required to pattern the entire thickness of the photoresist. The novel ultrasonic wave generators 250, 350, and 350′ described herein may be activated during and exposure process, simultaneously cleaning the surfaces that the fluid 206/306 comes into contact with and also increasing the process window of the exposure process. Note that in this embodiment, preferably the motion of the ultrasonic wave generator 250, 350, and 350′ is in the vertical direction (e.g., towards and away from the lens system 208/308) to maintain the integrity of the pattern being transferred from the lithography mask to the wafer 202 and 302.

The ultrasonic wave generators 250, 350, and 350′ of embodiments of the present invention preferably comprise devices adapted to generate ultrasonic waves. The ultrasonic waves may be inaudible and may comprise a frequency of about 50 kHz or less, for example. In one embodiment, the ultrasonic waves comprise a frequency of about 20 to 40 kHz, for example. The ultrasonic waves may also comprise frequencies of about 50 kHz or greater, for example. The ultrasonic waves generated by the ultrasonic wave generators 250, 350, and 350′ described herein may alternatively comprise other frequencies in accordance with embodiments of the present invention.

Ultrasonic cleaning is described in an article entitled, “Enhance Your Cleaning Process with Ultrasonics,” at the website: http://www.pfonline.com/articles/040003.html, which is incorporated herein by reference, for example. The ultrasonic wave generators 250, 350, and 350′ may comprise one or more ultrasonic transducers mounted to a radiating diaphragm and an electrical generator, for example (not shown). The ultrasonic transducers may comprise piezoelectric or magnetostrictive transducers, as examples, although alternatively, other ultrasonic transducers may be used. The radiating diaphragm of the ultrasonic wave generators 250, 350, and 350′ may comprise a mechanical vibrating device that produces positive and negative pressure waves, creating the ultrasonic waves that essentially vibrate the fluid 206 and 306 and cleans the surfaces the fluid 206 and 306 makes physical contact with.

The transducers of the ultrasonic wave generators 250, 350, and 350′ induce amplified vibrations of the diaphragm, producing the positive and negative pressure waves, which propagate through the fluid 206 and 306. The pressure waves create a cavitation process that produces bubbles. In general, the lower the frequency is, the more powerful the cavitation process is, and larger imploding bubbles are produced having more energy. The higher the frequency is, the less aggressive the cavitation process is and smaller imploding bubbles are produced.

In general, the cavitation process is affected by several variables, such as the ultrasonic frequency, time, chemistry concentration, load size, contamination level, power density, solvent type, part geometry, basket/rack configuration, contamination geometry, cavitation uniformity, fluid 206 and 306 temperature, part material, contamination type, and fluid filtration, as examples. The frequency of the ultrasonic waves generated may be adjusted according to the one or more of these variables for a particular application and debris problem, for example.

In particular, if the ultrasonic wave generator 250, 350, and 350′ is activated during the exposure process, the frequency and amplitude of the ultrasonic waves generated by the ultrasonic wave generators 250, 350, and 350′ may be adjusted and tuned to obtain the desired varying focus for the exposure process, e.g., to achieve a desired depth within the photoresist during the ultrasonic wave generator 250, 350, and 350′ activation, simultaneously with the exposure process.

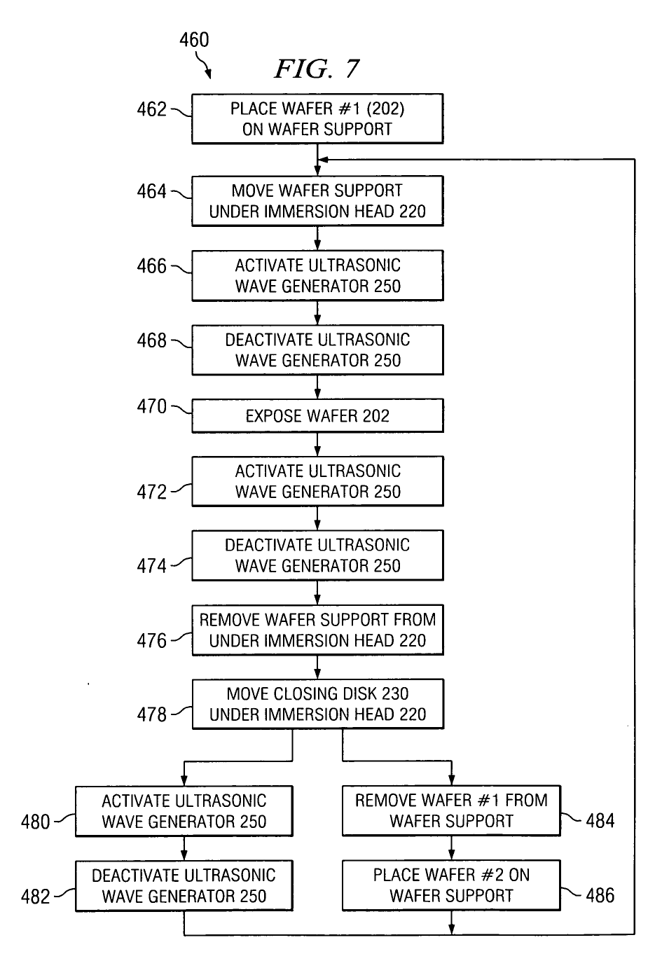

FIG. 7 is a flow chart 460 illustrating an exemplary method of cleaning an immersion exposure tool 200 or 300 (see FIGS. 5 and 6, respectively) in a typical exposure sequence in accordance with an embodiment of the present invention. Generally, the fluid 206/306 continuously flows into and out of the area just beneath the immersion head 220/320 during the entire exposure process, to maintain the temperature of the components of the immersion exposure tool 200/300, for example. Referring to the flow chart 460 of FIG. 7 and also to FIG. 5, first, a wafer 202 (e.g., wafer #1) is placed on the wafer support (step 462) of the immersion exposure tool 200. The wafer support is moved under the immersion head 220 (step 464).

Preferably, in one embodiment, the wafer 202 is cleaned before exposure. For example, in this embodiment, the ultrasonic wave generator 250 is activated (step 466), cleaning the wafer 202 and other surfaces the fluid 206 contacts. The ultrasonic wave generator 250 is then deactivated (step 468).

The wafer 202 is then exposed using the immersion exposure tool 200 (step 470). The exposure process may produce debris released from the resist, for example; therefore, the cleaning process may optionally be repeated at this point. The ultrasonic wave generator 250 is activated (step 472), cleaning the wafer 202 and other surfaces the fluid 206 contacts. The ultrasonic wave generator 250 is then deactivated (step 474).

The wafer support is removed from under the immersion head 220 (step 476). The closing disk 230 is moved under the immersion head 220 to close the immersion head 220 (step 478).

Next, while the immersion head 220 is closed, optionally, the system 200 may be cleaned again at this point. For example, the ultrasonic wave generator 250 is activated (step 480), cleaning the closing disk and other surfaces the fluid 206 contacts. The ultrasonic wave generator 250 is then deactivated (step 482). Simultaneously, or at a different time period, the wafer 202 may be removed from the wafer support (step 484), and another wafer 202, e.g., wafer #2, may be placed on the wafer support (step 486) in preparation for exposure of another wafer. The process is then repeated starting with step 464, and repeated for each wafer that is to be exposed.

Optionally, cleaning steps 466 and 468, 472 and 474, and/or 480 and 482 may be performed. For example, one aforementioned pair of cleaning steps such as 472 and 474, but not the others, may be performed in one embodiment. In another embodiment, a combination of two pairs of cleaning steps may be performed. In yet another embodiment, all three pairs of cleaning steps may be performed.

Each time the ultrasonic wave generator 250, 350, and 350′ is activated, the ultrasonic wave generator 250, 350, and 350′ preferably remains activated for about 5 minutes or less, although alternatively, the ultrasonic wave generator 250, 350, and 350′ may be activated for other periods of time to clean the immersion exposure tool 200/300. In another embodiment, the ultrasonic wave generator 250, 350, and 350′ may remain activated during the exposure process, as previously described herein.

In accordance with one embodiment of the present invention, a method of lithography for semiconductor devices includes providing an immersion exposure tool having a wafer support, a lens system, and an immersion head adapted to dispose a fluid between the lens system and the wafer support, and providing a workpiece having a radiation sensitive material disposed thereon. The workpiece is positioned on the wafer support, and a fluid is disposed between the workpiece and the lens system using the immersion head. An ultrasonic wave generator is coupled to the fluid or to a component of the immersion exposure tool that makes contact with the fluid, and the ultrasonic wave generator is activated to clean surfaces the fluid makes contact with. The ultrasonic wave generator is deactivated, and the workpiece is exposed to radiation using the immersion exposure tool.

Advantages of preferred embodiments of the present invention include providing novel methods of cleaning immersion exposure tools 200 and 300, and immersion exposure tools 200 and 300 adapted to implement the cleaning methods described herein. A decreased amount of debris and particulates in immersion exposure tools and improved semiconductor device yields of devices manufactured using the immersion exposure tools are achieved. The ultrasonic wave generator 250, 350, and 350′ dislodges any particulates that the fluid 206 and 306 comes into contact with, and the fluid 206 and 306 carries the particulates out of the immersion exposure tool and out of the path of the radiation beam. The ultrasonic wave generator 250, 350, and 350′ may be activated during an exposure process to increase the process window and avoid multiple exposures, simultaneously cleaning the immersion exposure tool 200 and 300 while exposing the wafer.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of cleaning an immersion exposure tool having a wafer support, a lens system, and an immersion head adapted to dispose a fluid between the lens system and the wafer support, wherein the method comprises:
coupling an ultrasonic wave generator to the fluid or to a component of the immersion exposure tool that makes contact with the fluid; and
activating the ultrasonic wave generator.

2. The method according to claim 1, wherein coupling the ultrasonic wave comprises coupling the ultrasonic wave generator to the immersion head.

3. The immersion exposure tool according to claim 1, wherein coupling the ultrasonic wave generator comprises coupling the ultrasonic wave generator to the wafer support.

4. The method according to claim 1, wherein coupling the ultrasonic wave generator comprises coupling the ultrasonic wave generator to the lens system.

5. The method according to claim 1, wherein the immersion head comprises at least one input port and at least one output port, further comprising flowing the fluid from the at least one input port to the at least one output port while activating the ultrasonic wave generator.

6. The method according to claim 1, wherein coupling the ultrasonic wave generator comprises coupling an ultrasonic wave generator adapted to produce ultrasonic waves at a frequency of about 50 kHz or less.

7. The method according to claim 1, further comprising placing a workpiece having a radiation sensitive material disposed thereon into the wafer support, and moving the immersion head proximate the workpiece, before or after activating the ultrasonic wave generator.

8. The method according to claim 1, further comprising placing a workpiece having a radiation sensitive material disposed thereon into the wafer support, moving the immersion head proximate the workpiece, and exposing the radiation sensitive material using the immersion exposure tool while activating the ultrasonic wave generator.

9. The method according to claim 1, further comprising coupling a closing disk to the immersion head, and moving the immersion head proximate the closing disk, before or after activating the ultrasonic wave generator.

10. The method according to claim 1, further comprising deactivating the ultrasonic wave generator after a time period of about 5 minutes or less.

11. The method according to claim 1, further comprising placing the immersion head proximate the wafer support to clean the wafer support.

12. The method according to claim 11, wherein the wafer support comprises at least one pocket formed in a top surface thereof, wherein activating the ultrasonic wave generator cleans the at least one pocket of the wafer support.

13. The method according to claim 1, further comprising placing a wafer in the wafer support, wherein activating the ultrasonic wave generator cleans the wafer.

14. A method of lithography for semiconductor devices, the method comprising:
providing an immersion exposure tool having a wafer support, a lens system, and an immersion head adapted to dispose a fluid between the lens system and the wafer support;
providing a workpiece having a radiation sensitive material disposed thereon;
positioning the workpiece on the wafer support;
disposing the fluid between the workpiece and the lens system;
coupling an ultrasonic wave generator to the fluid or to a component of the immersion exposure tool that makes contact with the fluid;
activating the ultrasonic wave generator to clean surfaces the fluid makes contact with;
deactivating the ultrasonic wave generator; and
exposing the workpiece to radiation using the immersion exposure tool.

15. The method according to claim 14, wherein coupling the ultrasonic wave comprises coupling the ultrasonic wave generator to the immersion head, to the wafer support, to the lens system, or only to the fluid.

16. The method according to claim 14, wherein the immersion head comprises at least one input port and at least one output port, further comprising flowing the fluid from the at least one input port to the at least one output port while activating the ultrasonic wave generator.

17. The method according to claim 16, wherein activating the ultrasonic wave generator is performed when a wafer is positioned in the wafer support, when a wafer is not positioned in the wafer support, or when a closing disk is positioned over the immersion head.

18. The method according to claim 14, wherein exposing the workpiece to radiation is before deactivating the ultrasonic wave generator.

19. An immersion exposure tool, comprising:
a lens system;
a wafer support;
an immersion head disposed between the lens system and the wafer support, the immersion head being adapted to dispose a fluid between the lens system and the wafer support; and
an ultrasonic wave generator coupled to the fluid or to a component of the immersion exposure tool that makes contact with the fluid.

20. The immersion exposure tool according to claim 19, wherein the ultrasonic wave generator is coupled to the immersion head, to the wafer support, the lens system, or to the fluid.

21. The immersion exposure tool according to claim 19, further comprising an energy source proximate the lens system.

22. The immersion exposure tool according to claim 21, wherein the ultrasonic wave generator is coupled to the wafer support and is adapted to move the wafer support in a direction towards and away from the lens system, wherein the immersion exposure tool is adapted to expose a wafer mounted on the wafer support while the ultrasonic wave generator is activated.

23. The immersion exposure tool according to claim 19, wherein the immersion head comprises at least one fluid input port and at least one fluid output port.

24. The immersion exposure tool according to claim 23, further comprising a closing disk disposed on the wafer support or a stage proximate the wafer support, the closing disk or stage being adapted to seal the fluid of the immersion head, wherein the immersion exposure tool may be cleaned by activating the ultrasonic wafer generator while fluid is passed from the at least one fluid input port to the at least one fluid output port with the closing disk or stage positioned under the immersion head.

25. The immersion exposure tool according to claim 23, wherein the immersion exposure tool may be cleaned by activating the ultrasonic wave generator while fluid is passed from the at least one fluid input port to the at least one fluid output port, with or without a wafer positioned in the wafer support.
